(19) United States
(12) Patent Application Publication
(10) Pub. No.: US 2004/0245100 A1
(43) Pub. Date: Dec. 9, 2004

(54) Method, system and apparatus for testing electrochemical cells

(76) Inventor: Rami Michel Abouatallah, Toronto (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/845,191

(22) Filed: May 14, 2004

Related U.S. Application Data
(60) Provisional application No. 60/470,189, filed on May 14, 2003.

(51) Int. Cl. G01N 27/26

(52) U.S. Cl. 204/400

(57) ABSTRACT

Embodiments of the invention relate to apparatus, systems and methods for testing for short-circuited cells within an electrochemical cell stack. In order to test for a short-circuit, each cell in the stack is supplied with a non-fuel gas at both the anode and cathode sides of the cell. A voltage is supplied across the whole electrochemical cell stack and the individual electrical potentials (ie. voltages) between the anode and cathode of each cell is measured. If the voltage measured across the anode and cathode of a cell is below a certain amount, the cell is determined to be short-circuited.

### RELATED APPLICATIONS

This application relates to, and claims priority from, U.S. Provisional patent application Ser. No. 60/470,189 filed May 14, 2003, the contents of which is hereby incorporated by reference.

### FIELD OF THE INVENTION

The present invention relates to a method, system and apparatus for testing for a short circuit of an electrochemical cell. In particular, the invention relates to detecting a short circuit of an electrochemical cell within a plurality of electrochemical cells.

### BACKGROUND OF THE INVENTION

Fuel cells and electrolyzer cells are usually collectively referred to as electrochemical cells. Fuel cells have been proposed as a clean, efficient and environmentally friendly power source that has various applications. A conventional proton exchange membrane (PEM) fuel cell is typically comprised of an anode, a cathode, and a selective electrolytic membrane disposed between the two electrodes. A fuel cell generates electricity by bringing a fuel gas (typically hydrogen) and an oxidant gas (typically oxygen) respectively to the anode and the cathode. In reaction, a fuel such as hydrogen is oxidized at the anode to form cations (protons) and electrons by the reaction: H₂=2H⁺+2e⁻.

The proton exchange membrane facilitates the migration of protons from the anode to the cathode while preventing the electrons from passing through the membrane. As a result, the electrons are forced to flow through an external circuit thus providing an electrical current. At the cathode, oxygen reacts with electrons returned from the electrical circuit to form anions. The anions formed at the cathode react with the protons that have crossed the membrane to form liquid water as the by-product following the reaction: ½O₂+2H⁺+2e⁻=H₂O.

An electrolyzer cell uses electricity to electrolyze water to generate oxygen from its anode and hydrogen from its cathode. Similar to a fuel cell, a typical solid polymer water electrolyzer (SPWE) or proton exchange membrane (PEM) electrolyzer is also comprised of an anode, a cathode and a proton exchange membrane disposed between the two electrodes. Water is introduced to, for example, the anode of the electrolyzer which is connected to the positive pole of a suitable direct current voltage. Oxygen is produced at the anode by the reaction: H₂O=½O₂+2H⁺+2e⁻.

The protons then migrate from the anode to the cathode through the membrane. On the cathode which is connected to the negative pole of the direct current voltage, the protons conducted through the membrane are reduced to hydrogen following the reaction: 2H⁺+2e⁻=H₂.

In practice, electrochemical cells are not operated as single units. Rather, electrochemical cells are connected in series, either stacked one on top of the other or placed side by side. The series of cells is usually referred to as a stack.

A common problem in electrochemical cell stacks is electrical shorting of individual cells within the stack. A cell may become shorted in a number of different ways. For example, if the membrane electrode assembly is damaged or punctured, the anode and cathode may be in direct contact with each other, resulting in a short circuit across the membrane. In another example, if the seal is imperfect and does not completely separate the anode and cathode plates from each other, this will also result in a short circuit of the cell.

A short circuit of one or more cells in a fuel cell stack reduces the efficiency of the stack because it reduces the number of cells available for power generation. For electrolyzer cell stacks, the shorting problems render some cells unavailable for electrolysis reaction. Shorting may also lead to damage of cells and hence is highly undesirable.

The present invention aims to provide a way of testing for a short circuit of one or more cells within an electrochemical cell stack.

### SUMMARY OF THE INVENTION

In accordance with a first aspect of the present invention, there is provided an apparatus for testing for a short circuit in at least one electrochemical cell. The apparatus comprises a gas supply for supplying a non-fuel gas to an anode side and a cathode side of the at least one electrochemical cell, a voltage supply for supplying a test voltage across the at least one electrochemical cell and a voltage monitor for measuring a cell voltage of each at least one electrochemical cell.

In accordance with a further aspect of the present invention, there is provided a method for testing for a short circuit in at least one electrochemical cell. The method comprises supplying a non-fuel gas to an anode side and a cathode side of the at least one electrochemical cell, supplying a test voltage across the at least one electrochemical cell and measuring a cell voltage of the at least one electrochemical cell.

In accordance with a still further aspect of the invention, there is provided a system for testing a plurality of electrochemical cells connected in series. The system comprises a gas supply for supplying a non-fuel gas to an anode side and a cathode side of each electrochemical cell of the plurality of electrochemical cells, a voltage supply for supplying a first voltage across the plurality of electrochemical cells and a voltage monitor for measuring a second voltage between respective electrodes at the anode side and cathode side for each electrochemical cell.

Advantageously, the measured cell voltage (or second voltage) can be used to determine whether the cell is short-circuited.

### BRIEF DESCRIPTION OF THE DRAWINGS

For a better understanding of the present invention and to show more clearly how it may be carried into effect, reference will now be made, by way of example, to the accompanying drawings which show a preferred embodiment of the present invention and in which:

FIG. 1 is a schematic diagram of an apparatus for testing for a short circuit of one or more cells within an electrochemical cell stack, in accordance with one embodiment of the present invention;

FIG. 2 is a graph of an example display output of measurement results obtained in the testing; and

FIG. 3 is a schematic diagram of a system for testing for a short circuit of one or more cells within an electrochemical cell stack, in accordance with another embodiment of the invention.

### DETAILED DESCRIPTION OF THE INVENTION

Preferred embodiments are described hereinafter, with reference to the drawings. Like reference numerals are used to indicate like features or functions as between the drawings and/or embodiments.

It should be understood by persons skilled in the art that, while the following description refers mainly to fuel cells which consume hydrogen gas and generate water, embodiments of the invention are equally applicable to other electrochemical cells, such as electrolyzer cells, which consume water and generate hydrogen gas. In particular, embodiments of the invention are applicable to electrochemical cells having opposed electrodes separated by a thin membrane or seal, where the cells are arranged in a stack.

Embodiments of the invention generally relate to an apparatus and a system for testing the fuel cells within a fuel cell stack for determining whether one or more of those fuel cells is short-circuited. Embodiments also relate to methods for testing for a short-circuit using the apparatus and system.

Embodiments of the invention are particularly applicable for testing a fuel cell stack after assembly of the stack has been mostly or fully completed, as part of a quality assurance procedure performed prior to sale or use of the fuel cell stack. The fuel cell stack may be assembled either as part of a fuel cell power generation module or on its own. This testing is performed after assembly because manufacturing errors are one possible source of defects in the cells or components thereof, which may lead to short-circuiting of a cell, which in turn degenerates the overall performance of the fuel cell stack.

In another scenario, embodiments of the inventions may be employed to test a stack that has been in use for some time, for example to perform one of several diagnostic tests on the fuel cell stack to determine the cause of sub-optimal performance of the stack.

Testing of a newly manufactured fuel cell stack is performed similarly to that of a used fuel cell stack, except that a fuel cell stack that has been in operation will need to be purged of any fuel gas prior to testing.

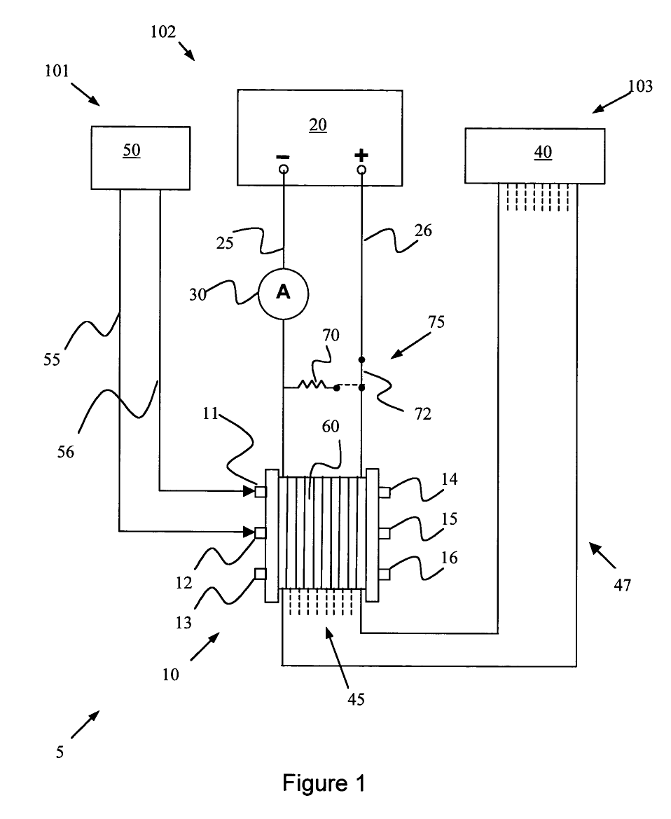

Referring now to FIG. 1, there is shown a short-circuit testing apparatus 5. Short-circuit testing apparatus 5 includes a gas supply system 101, voltage supply system 102 and voltage monitoring system 103, each interacting with a fuel cell stack 10.

The fuel cell stack 10 includes a number of fuel cells 60. The number of fuel cells 60 in the fuel cell stack 10 may vary from a small number, such as 1 or 2, to a large number, such as 100 or more. A common number of fuel cells in a stack is 60.

Each fuel cell 60 in fuel cell stack 10 has an anode side (not shown) having a flow field for receiving a fuel gas such as hydrogen gas and an anode plate (not shown) acting as one of the fuel cell electrodes. Each fuel cell 60 also as a cathode side (not shown) having a flow field for receiving a reactant gas such as air or oxygen and has a cathode plate (not shown) acting as an electrode of opposite polarity to that of the anode plate. A membrane, such as a PEM, and a seal separate the anode and cathode sides so as to prevent the electrode plates from contacting each other and hence short-circuiting the cell. While preferred embodiments are described herein with reference to Hydrogen fuel cells having a proton exchange membrane, it should be understood that the invention is applicable to any form of electrochemical cell having opposed, separated electrodes. Specifically, the invention is applicable to cells using a solid polymer electrolyte, including either cation and anion exchange membranes.

Fuel cell stack 10 has an anode inlet 11 for receiving gas and distributing it to the anode side of each fuel cell 60. Similarly, a cathode inlet 12 on fuel cell stack 10 receives gas for distribution to the cathode side of each fuel cell 60. A coolant inlet 13 is provided on fuel cell stack 10 for receiving coolant during normal operation of the stack 10, although no coolant is required for short-circuit testing according to embodiments of the present inventions. Anode outlet 14, cathode outlet 15 and coolant outlet 16 are also provided on fuel cell stack 10. While coolant outlet 16 is not required for short-circuit testing, anode outlet 14 and cathode outlet 15 may be used for venting of non-fuel test gases used during short-circuit testing, or may be coupled to respective gas return lines (not shown) feeding back to gas supply 50.

Alternatively, anode and cathode outlets 14, 15 may be blocked during testing and the non-fuel gas can be supplied to the fuel cell stack in a “dead-end” manner, such that the non-fuel gas does not flow out of the stack. However, anode and cathode outlets 14, 15 should not be blocked when the stack is being purged of fuel gas.

Gas supply system 101 includes gas supply 50 and gas supply lines 55, 56. Gas supply line 56 feeds into anode inlet 11 and gas supply line 55 supplies gas to cathode inlet 12. Gas supply 50 includes at least one gas storage tank (not shown) for storing and supplying an inert or relatively inert gas (ie. a non-fuel gas) to anode and cathode inlets 11 and 12 of fuel cell stack 10. The gas storage tank keeps the supply gas under pressure but the gas supply 50 may also include a compressor, blower or fan for assisting in delivery of the supply gas to the fuel cell stack 10.

Gas supply 50 supplies inert gas or air, which is sufficiently inert for the purpose of short-circuit testing. If air is supplied as the non-fuel gas to fuel cell stack 10 during testing, any fuel gas, such as hydrogen, should be purged, using an inert gas from the fuel cell stack 10 prior to supply of the air. If Hydrogen remains in the anode side of the cell when air is supplied thereto, Oxygen in the air is likely to combust with the Hydrogen. Also, if Hydrogen remains at the anode side when air is supplied to the cathode side, the fuel cell may begin to operate in a current generation mode, which will disrupt the testing and create anomalous voltage measurements. Purging will also serve to flush water or other contaminants from the anode and cathode sides of the stack.

During purging of the anode and cathode sides, a relatively forceful flush of inert gas is applied from gas supply 50. Once the purge is complete and the stack is ready for short-circuit testing, the non-fuel gas is applied at a relatively low pressure. Although it is possible to purge the stack with a short, forceful burst of air, this runs the risk of combustion within the cell or stack and is therefore not preferred.

Reference herein to “non-fuel gas” is intended to indicate a gas which will not be consumed as part of a normal operation of the cell. For example, for a Hydrogen fuel cell, any gas other than one which comprises Hydrogen may be used, providing it is suitable for use in a fuel cell, including being sufficiently clean, inert and non-toxic to the fuel cell materials. For an electrolyzer cell, which consumes water during normal operation, a non-fuel gas will be any suitable gas which does not comprise Hydrogen, providing it is suitable for use in an electrolyzer cell, including being sufficiently clean, inert and non-toxic to the electrolyzer cell materials.

In one embodiment, gas supply 50 includes a storage tank for inert gas and a separate storage tank for air. Alternatively, air may be drawn from the operating environment through gas supply 50, without use of a dedicated storage tank.

A preferred inert gas for supply to fuel cell stack 10 during short-circuit testing is nitrogen, although other inert gases, such as argon or helium, may be used. If air is used as the non-fuel gas during testing, it is preferably filtered through a suitable filter (not shown) in gas supply system 101.

Voltage supply system 102 includes a voltage supply 20, an ammeter 30 (or other current sensing device) and a discharge circuit 75. Voltage supply system 102 further includes an active supply conductor 25 and a passive supply conductor 26, forming a circuit interconnecting voltage supply 20 and fuel cell stack 10 so as to supply a direct current (DC) voltage thereto.

Voltage supply 20 is preferably a 24 volt DC supply where fuel cell stack 10 has about 60 fuel cells 60. In another example, for 100 fuel cells 60 in fuel cell stack 10, a 48 volt DC supply may be used as voltage supply 20.

Under normal operation of a fuel cell during power generation, each fuel cell is effectively, in electrical circuit terms, a resistance coupled in parallel with a capacitance. The resistance is due to the effective current flow across the PEM, while the capacitance is due to the large anode and cathode plates separated from each other by a small distance. If the cell is not supplied with reactant gasses, the effective current flow across the PEM which would occur in a power generation mode is not present and the electrical circuit equivalent of the cell becomes a capacitance alone, with an open circuit in place of the resistance. The cells are electrically connected in series. When the cells are aggregated in a stack, the electrical circuit equivalent of the stack resembles a number of capacitors connected in series.

When voltage is supplied from voltage supply 20 to end terminals (not specifically shown) of fuel cell stack 10 (when not receiving any reactant gases), the plates of each cell act as a capacitor, which charges up.

Ammeter 30 is connected in series along active supply conductor 25 and is used to detect current flowing through the circuit formed by conductors 25, 26 and fuel cell stack 10 during testing. When voltage supply 20 is initially turned on, the anode and cathode plates of cells 60 in stack 10 will act as large capacitors (because there will be no current flow between the fuel cell plates in the test mode) and thus ammeter 30 will sense and display a transient current during this initial period. Once the effective charge of the fuel cells 60 reaches a relatively steady state, this will be reflected in a substantially stable (zero) current indication by ammeter 30.

Preferably, once a stable current is determined from ammeter 30, and the non-fuel test gas is being supplied from gas supply system 101, voltage monitoring system 103 is engaged to begin measuring the differences in electrical potential, which is effectively a voltage difference, between the anode and cathode plates of each fuel cell 60. If the current is not stable when the voltage monitor 40 is engaged, the measured cell voltage may fluctuate.

The voltage monitoring system 103 comprises a voltage monitor 40, a cable or wire harness 47 connecting the voltage monitor 40 to the stack and a plurality of cell contacts 45 for sensing the potentials of a respective plurality of fuel cells. A preferred voltage monitor is disclosed in commonly owned co-pending U.S. patent application Ser. No. 09/865,562, filed May 29, 2001, which is hereby incorporated by reference. U.S. patent application Ser. No. 09/865,562 is published under US Publication No. 2002-0180447-A1. Other forms of voltage monitor 40 may be employed, providing that they have the presently described features and perform the presently described functions.

The voltage monitor 40 comprises a plurality of differential amplifiers (not shown), a multiplexer (not shown), an analog to digital converter (not shown), a controller (not shown), and a display (not shown). Each of the differential amplifiers reads the voltages at two terminals of each fuel cell. The analog to digital converter reads the output of the differential amplifiers via the multiplexer, which provides access to one of these differential amplifiers at any given time. The digital output of the analog to digital converter is then provided to the controller for processing. The controller controls the operation of the analog to digital converter and the multiplexer processes the digital output and executes software instructions for displaying the processed digital output on a display such as an LCD or CRT display.

The cell contacts 45 may be prefabricated on the anode or cathode plates so as to protrude therefrom and allow for easy connection to corresponding wires (not shown) of a cable or wiring harness 47. Alternatively, cathode and/or anode tapping points for each cell may be electrically connected to an array of spring-loaded contact pins within a wiring harness connector socket or plug to enable easy connection to a corresponding plug or socket connector at the end of cable or wiring harness 47. Other suitable contact means may be employed so as to connect the cells of fuel stack 10 to voltage monitor 40 via cable or wiring harness 47.

If the fuel cell stack 10 has a large number of cells 60, for example in the order of 100 cells, voltage monitor 40 and cable or wiring harness 47 may be used to test groups of the cells one at a time for short-circuits within each group of cells. For example, if voltage monitor 40 and wiring harness 47 are only set up to test 30 cells at a time, a fuel cell stack 10 having 100 cells can be divided into four groups of cells for sequential testing (ie. three groups of 30 cells and one group of 10 cells). Further, the multiplexer of voltage monitor 40 may be configured to select only a subset of the cells for which it is connected to receive input, depending on the desired testing arrangement.

Voltage monitor 40 is configured to sample the cell voltages of fuel cell stack 10, or groups of cells thereof, in rapid succession, and to process the measured voltages for display so as to appear to an observer as if all of the cells were being monitored at the same time. Further, the cell voltage measurements must be sufficiently rapid to report brief transient conditions affecting the cells. It is preferred to perform a cell voltage measurement about every 10 milliseconds for each cell.

As a routine step or only for stacks previously in operation, the anode and cathode of the fuel cell stack 10 may be purged with an inert gas, for example, nitrogen, prior to testing to flush out residual reactants on the anode and cathode and remove any water from flooded cells. This ensures that the reading of cell voltages is not compromised by the presence of reactants and water. This purge operation is achieved by supplying inert gas from the gas storage tank to the fuel cell stack 10 and forces the nitrogen to flow through the anode and cathode sides of each cell 60 in the stack 10.

While the inert gas or air is continuously flowing through the anode and cathode sides of each fuel cell, the voltage supply 20 supplies a DC voltage to opposed end terminals of the fuel cell stack such that the cathode of the cell at one end of the stack is at a higher potential than the anode of the cell at the other end of the stack. The voltage monitor 40 measures the individual cell potentials (voltages) of each fuel cell 60. If a cell is not short-circuited, it is possible to detect a potential difference across each cell up to about the typical voltage of a fuel cell, for example, between 0.3 and 1.0 volt. However, if a cell is short-circuited for any reason, the detected potential difference across the cell will be considerably lower than that range, for example only a few millivolts.

Preferably, during the test, the DC voltage supplied by voltage supply 20 is gradually increased from zero to a maximum level (eg. 24 volts for a 60 cell stack). It is preferable that the DC voltage is applied such that the highest cell voltage detected by the voltage monitor 40 does not exceed a maximum cell voltage of the cells being tested. In normal operation, individual fuel cells usually generate a voltage below 1.0V. Accordingly the maximum cell voltage is preferably lower than 1.0V, for example, 0.5V. Beyond about 1.2V, the cell may be damaged.

The maximum cell voltage is determined according to the design, configuration and materials of the cells to be tested and may vary accordingly. The output of voltage supply 20 is limited to ensure that no cells are damaged during the short circuit test. As the DC voltage increases, the measured current in ammeter 30 changes. It is preferable to wait until the reading of the ammeter 30 is stable for a certain period of time, for example, 30 seconds up to a few minutes, to record the cell voltages measured by the voltage monitor 40.

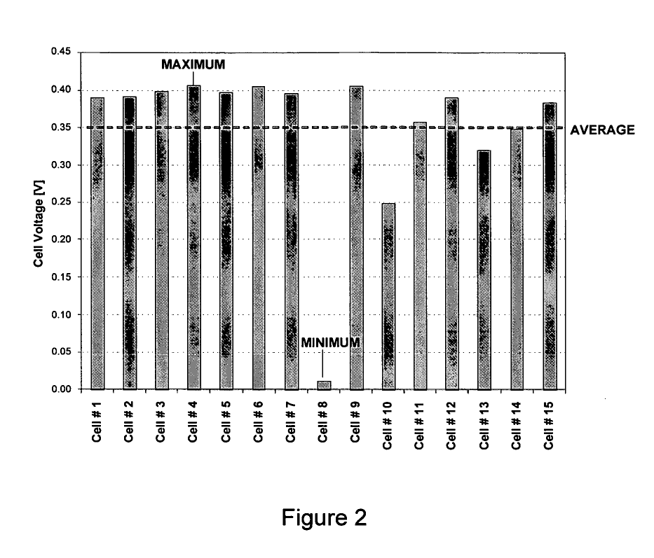

FIG. 2 shows an example display of a graph of measured cell voltages generated by voltage monitor 40. In the example, normal cells have cell voltages in the range of 0.25 to 0.45 volts. Cell #8 is short-circuited and hence has a cell voltage much lower (eg. about 20 millivolts) than those of the normal cells.

In the graph in FIG. 2, an average cell voltage line is indicated at about 0.35V. This average cell voltage is calculated as the average of all of the voltages of cells 1 to 15. Alternatively, the average may be calculated as the average cell voltages of all cells except that which is determined to be the minimum cell voltage, in this case cell number 8. The calculated average cell voltage is used to determine, for each cell, whether the cell voltage of that cell is low enough such that the cell is likely to be short-circuited. For example, if the voltage of a cell is less than a threshold voltage, defined with respect to the average, this may be considered to indicate a short-circuit in that cell. The threshold may be, for example, a fraction of the average, such as one third or one half. As a further alternative, the threshold may be defined without reference to the average of the cell voltages, being instead a set voltage level, such as 0.05V.

As a further alternative to using the average of the cell voltages to determine a threshold, the threshold voltage may be determined as a fraction of the maximum cell voltage measured among all of the cells. Such a threshold may be, for example, one fifth of the highest measured cell voltage.

If the cell voltages are seen to fluctuate somewhat over time, this may make it difficult to determine a reliably fixed average over all of the cells. In such a case, each cell voltage displayed in the graph may be a time averaged amount of the measured cell voltages over a certain period of time, such as several seconds. The calculations for generating a graph display such as that illustrated in FIG. 2 are performed by the controller of voltage monitor 40 or alternatively, may be performed by an additional computer processor with which the controller is in communication, such as is described in U.S. patent application Ser. No. 09/865,562.

After the fuel cell stack 10 is tested for short circuits, the apparatus 5 may be disconnected from the stack and applied to the next stack to be tested.

Preferably, after being tested but prior to disconnection the fuel cell stack 10 is discharged by connecting resistor 70 across the cells. Referring again to FIG. 1, discharge circuit 75 is used to discharge any residual charge in the stack through discharge resister 70. Discharge resister 70 is preferably a power resister having a rating for 60 watts of power and 60 ohms.

Discharge circuit 75 also includes a discharge switch 72 which, during short-circuit testing of fuel cell stack 10, is positioned so as to complete the circuit between voltage supply 20 and fuel cell stack 10. Once the short-circuit testing is completed, discharge switch 72 is switched so as to create an open circuit in conductor 26 and close a circuit between discharge resister 70 and fuel cell stack 10. Optionally, a further ammeter (not shown) may be connected in series with discharge resister 70 so as to enable an operator of the apparatus to determine when the fuel cell stack has sufficiently discharged through discharge resister 70.

Discharge switch 72 may be manual or may be indirectly actuated through another device, for example such as a voltage supply 20 or a relay (not shown) included within the voltage supply system 102.

Discharge circuit 75 may be arranged in an alternative configuration as appropriate, for example as a separate circuit from the voltage supply circuit.

Preferably, short-circuit testing apparatus 5 includes a cabinet or portable housing for enclosing gas supply system 101, voltage supply system 102 and voltage monitoring system 103 together. This cabinet preferably has at least some basic input and output. For example, discharge switch 72 may be actuated by a manual switch on the cabinet, ammeter 30 may have an analogue display mounted on the cabinet, gas supply 50 from gas supply subsystem 101 may be activated by one or more switches on the cabinet and a display controlled by voltage monitor 40 may also be mounted on the cabinet.

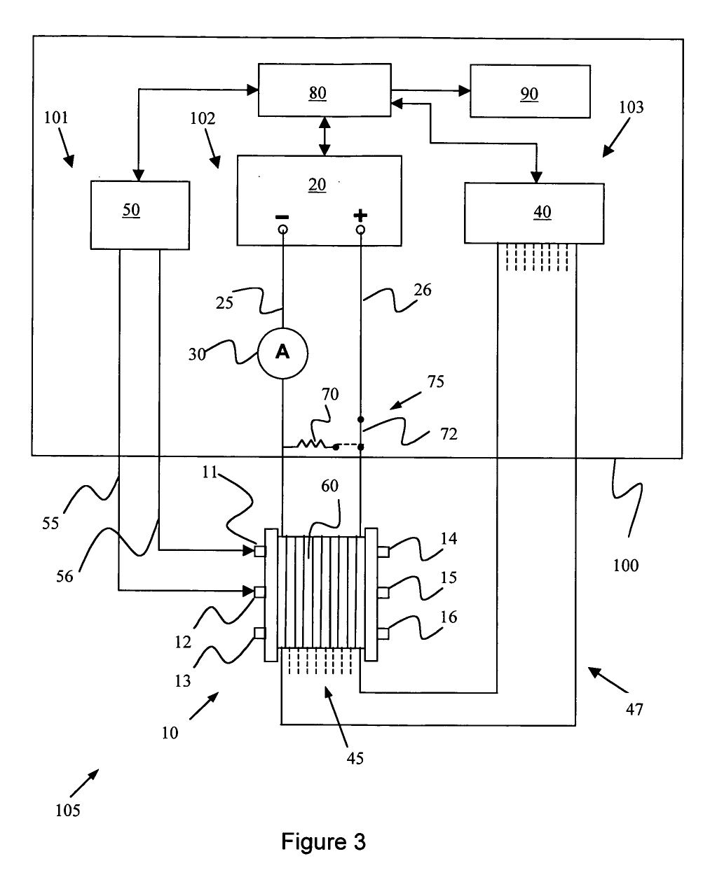

Referring now to FIG. 3, there is shown a short-circuit testing system 105 substantially similar in function to short-circuit testing apparatus 5, except with added functionality in the form of a computer processing unit 80 and a dedicated LCD or CRT display 90. Like reference numerals in FIG. 3 refer to like features or functions as described in relation to FIG. 1 and will therefore not be repeated in relation to FIG. 3.

Short-circuit testing system 105 includes a system enclosure 100 for housing voltage supply 20, ammeter 30, voltage monitor 40, gas supply 50, discharge circuit 75, computer 80 and display 90. In order to conduct the short-circuit testing on fuel cell stack 10, cable or wiring harness 47 extends from the system enclosure 100, as do conductors 25, 26 and gas supply lines 55, 56.

Computer 80 includes appropriate input and output devices, such as a keyboard and mouse and other devices which would normally be associated with a personal computer, and a central processing unit for executing software to control the gas supply system 101, the voltage supply system 102, the voltage monitoring system 103 and display 90. Computer 80 enables a user of the short-circuit testing system 105 to provide control commands through a keyboard and mouse, for example, while viewing display 90.

Preferably, computer 80 includes a programmable controller for controlling actuation of any valves, blowers, etc. in gas supply system 101, as well as operating a switching relay so as to provide power to voltage supply system 102 from mains power through a transformer (for example). Preferably, short-circuit testing system 105 (and short-circuit apparatus 5) runs on mains power, which feeds each of the system components, as necessary, either directly or through an appropriate transformer and/or rectifier.

The programmable controller of computer 80 is further adapted to monitor the voltage supply, current and discharge characteristics of voltage supply system 102 and inform the user of these characteristics through display 90 via the appropriate software on computer 80. Similarly, the programmable controller communicates with the controller of voltage monitor 40 for initiating the monitoring procedure and receiving digital voltage outputs for display on display 90. The programmable controller may also receive status signals from the valves, blowers, pressure indicators, etc. of gas supply system 101.

In short-circuit testing system 105, instead of voltage monitor 40 performing the calculations for generating a display such as that illustrated in FIG. 2, this is preferably performed by computer 80 in communication with the controller of voltage monitor 40.

As mentioned above, the present invention is also applicable for electrolyzer cells. It will be appreciated by those skilled in the art that when electrolyzer cells are tested, the voltage supply 20 should be connected to the stack such that the anode of each electrolyzer cell is at a higher potential than the cathode of that cell. Other aspects of the method for conducting the test are same as those for fuel cells and hence will not be repeated herein for simplicity.

The present invention is also applicable to testing for a short circuit in a single fuel cell. In this case, the stack effectively consists of only one cell. The voltage supply 20 is connected to the single fuel cell such that the cathode of the cell is at a higher potential than the anode.

It should be further understood that various modifications can be made by those skilled in the art to the preferred embodiments described and illustrated herein, without departing from the spirit and scope of the present invention.

1. An apparatus for testing for a short circuit in at least one electrochemical cell, comprising:
a gas supply for supplying a non-fuel gas to an anode side and a cathode side of the at least one electrochemical cell;
a voltage supply for supplying a test voltage across the at least one electrochemical cell; and
a voltage monitor for measuring a cell voltage of each at least one electrochemical cell.

2. The apparatus of claim 1, further comprising a voltage supply system which comprises the voltage supply and a current measuring device for measuring current flowing through the at least one electrochemical cell.

3. The apparatus of claim 2, wherein the test voltage is a DC voltage.

4. The apparatus of claim 3, wherein the voltage supply system is arranged to increase the DC voltage from zero and the voltage monitor is arranged to measure the cell voltage of each at least one electrochemical cell once the current measured by the current measuring device is determined to be stable.

5. The apparatus of claim 1, wherein the voltage supply to the at least one electrochemical cell is supplied such that the highest cell voltage does not exceed a maximum voltage.

6. The apparatus of claim 5, wherein the maximum voltage is in the range of 0.5-1.2 volt.

7. The apparatus of claim 1, wherein each at least one electrochemical cell is a fuel cell and wherein the test voltage is supplied to the at least one fuel cell such that a cathode of each at least one fuel cell is at a higher voltage than an anode of the same cell.

8. The apparatus of claim 1, wherein each at least one electrochemical cell is an electrolyzer cell and wherein the test voltage is supplied to the at least one electrolyzer cell such that an anode of each at least one electrolyzer cell is at a higher voltage than a cathode of the same cell.

9. The apparatus of claim 1, further comprising a discharge circuit for discharging the at least one electrochemical cell after the cell voltage has been measured.

10. The apparatus of claim 9, wherein said discharge circuit comprises a discharge resistor connectable across the at least one electrochemical cell.

11. The apparatus of claim 10, wherein said discharge circuit comprises a switch for connecting the discharge resistor across the at least one electrochemical cell.

12. The apparatus of claim 1, wherein the non-fuel gas consists substantially of inert gas or air.

13. The apparatus of claim 1, wherein the gas supply further comprises a gas storage tank for storing and supplying said non-fuel gas to the anode side and cathode side of the at least one electrochemical cell.

14. The apparatus of claim 1, wherein the at least one electrochemical cell comprises part of an electrochemical cell stack having a plurality of electrochemical cells.

15. The apparatus of claim 1, wherein the voltage monitor comprises a multiplexer for selecting each at least one electrochemical cell for measuring a cell voltage thereof.

16. The apparatus of claim 15, wherein the multiplexer is adapted to select each at least one electrochemical cell in a rapidly repeating sequence.

17. The apparatus of claim 1, wherein the voltage monitor comprises a display for displaying the measured cell voltage of each at least one electrochemical cell.

18. The apparatus of claim 15, wherein the voltage monitor is arranged to determine that the at least one electrochemical cell is short-circuited if the measured cell voltage of the respective electrochemical cell is less than a threshold voltage.

19. The apparatus of claim 18, wherein the threshold voltage is a predetermined voltage.

20. The apparatus of claim 18, wherein the threshold voltage is based on the measured cell voltages of the electrochemical cells.

21. The apparatus of claim 20, wherein the threshold voltage is based on a fraction of the average of the measured voltages.

22. A method for testing for a short circuit in at least one electrochemical cell, comprising:
supplying a non-fuel gas to an anode side and a cathode side of the at least one electrochemical cell;
supplying a test voltage across the at least one electrochemical cell; and
measuring a cell voltage of the at least one electrochemical cell.

23. The method of claim 22, further comprising measuring a current flowing to the at least one electrochemical cell.

24. The method of claim 23, wherein the test voltage is a DC voltage.

25. The method of claim 24, further comprising increasing the test voltage from zero and the step of measuring comprises measuring the cell voltage of each at least one electrochemical cell once the measured current is determined to be substantially stable.

26. The method of claim 22, wherein the step of supplying a test voltage is performed such that the highest cell voltage does not exceed a maximum cell voltage.

27. The method of claim 26, wherein the maximum cell voltage is in the range of 0.5-1.2 volts.

28. The method of claim 22, wherein each at least one electrochemical cell is a fuel cell and the test voltage is applied to the at least one fuel cell such that a cathode of each at least one fuel cell is at a higher voltage than an anode of the same cell.

29. The method of claim 22, wherein each at least one electrochemical cell is an electrolyzer cell and the test voltage is applied to the at least one electrolyzer cell such that an anode of each at least one electrolyzer cell is at a higher voltage than a cathode of the same cell.

30. The method of claim 22, further comprising discharging the at least one electrochemical cell through a discharge circuit after said step of measuring.

31. The method of claim 22, wherein the non-fuel testing gas consists substantially of inert gas or air.

32. The method of claim 22, further comprising purging the anode side and cathode side of each at least one electrochemical cell before supplying the non-fuel gas.

33. The method of claim 22, wherein the at least one electrochemical cell comprises part of an electrochemical stack having a plurality of electrochemical cells.

34. The method of claim 22, wherein the step of measuring comprises selecting each at least one electrochemical cell in a rapidly repeating sequence and measuring each selected electrochemical cell in said sequence.

35. The method of claim 22, further comprising the step of displaying the measured cell voltage of each at least one electrochemical cell.

36. The method of claim 22, further comprising, for each at least one electrochemical cell, the step of determining that the electrochemical cell is short-circuited if the measured cell voltage of the electrochemical cell is less than a threshold voltage.

37. A system for testing a plurality of electrochemical cells connected in series, the system comprising:
a gas supply for supplying a non-fuel gas to an anode side and a cathode side of each at least one electrochemical cell of the plurality of electrochemical cells;
a voltage supply for supplying a first voltage across the plurality of electrochemical cells; and
a voltage monitor for measuring a second voltage between respective electrodes at the anode side and cathode side of each electrochemical cell.

38. The system of claim 37, further comprising a voltage supply system which comprises the voltage supply and a current measuring device for measuring current flowing to the electrochemical cells.

39. The system of claim 38, wherein the voltage supply system is arranged to increase the first voltage from zero and the voltage monitor is arranged to measure the second voltage of each electrochemical cell once the current measured by the current measuring device is determined to be stable.

40. The system of claim 37, wherein the voltage supply to the electrochemical cells is supplied such that the highest cell voltage does not exceed a maximum cell voltage.

41. The system of claim 40, wherein the maximum cell voltage is in the range of 0.5-1.2 volt.

42. The system of claim 37, wherein each electrochemical cell is a fuel cell.

43. The system of claim 37, wherein each electrochemical cell is an electrolyzer cell.

44. The system of claim 37, further comprising a discharge circuit for discharging the plurality of electrochemical cells after the respective second voltages have been measured.

45. The system of claim 44, wherein said discharge circuit comprises a discharge resistor connectable across the plurality of electrochemical cells.

46. The system of claim 45, wherein said discharge circuit comprises a switch for connecting the discharge resister across the plurality of electrochemical cells.

47. The system of claim 37, wherein the non-fuel gas consists substantially of inert gas or air.

48. The system of claim 37, wherein the gas supply further comprises a gas storage tank for storing and supplying said non-fuel gas to the plurality of electrochemical cell.

49. The system of claim 37, wherein the voltage monitor comprises a multiplexer for selecting each electrochemical cell for measuring the second respective voltage thereof.

50. The system of claim 49, wherein the multiplexer selects each electrochemical cell in a rapidly repeating sequence.

51. The system of claim 37, wherein the voltage monitor comprises a display for displaying the measured cell voltage of each electrochemical cell.

52. The system of claim 37, wherein, for each electrochemical cell, the voltage monitor indicates that the electrochemical cell is short-circuited if the measured second voltage of the electrochemical cell is less than a threshold voltage.

53. The system of claim 52, wherein the threshold voltage is a predetermined voltage.

54. The system of claim 52, wherein the threshold voltage is based on the measured second voltages of the plurality of electrochemical cells.

55. The system of claim 54, wherein the threshold voltage is based on a fraction of the average of the measured second voltages.
